(19) United States
(12) Patent Application Publication
(10) Pub. No.: US 2007/0112594 A1
(43) Pub. Date: May 17, 2007

(54) Method and system for providing specialty medical services

(76) Inventor: Richard C. Davis, El Dorado Hills, CA (US)

Correspondence Address: ARENT FOX PLLC, 1050 CONNECTICUT AVENUE, N.W., SUITE 400, WASHINGTON, DC, 20036, US

(21) Appl. No.: 11/354,086

(22) Filed: Feb. 15, 2006

Related U.S. Application Data
(60) Provisional application No. 60/736,292, filed on Nov. 15, 2005.

(51) Int. Cl. G06Q 10/00; G06F 9/44

(52) U.S. Cl. 705/2; 705/7

(57) ABSTRACT

One or more discrete, scalable operating units are organized to facilitate local medical practices in incorporating apheresis treatment procedures, without substantial capital investment or disruption in practice operations. A parent company forms a management services organization, which in turn establishes one or more specialty apheresis facilities. The management services organization provides the office space and equipment for performance of apheresis treatments at the apheresis facility. The management services organization also staffs the apheresis facility with highly skilled medical personnel, including one or more medical directors to oversee the administrative aspects relating to the performance capabilities of the apheresis procedures. The management services organization forms a separate contractual relationship for the provision of management and administrative functions with local medical practices. The local medical practice employs a specialist apheresis physician to provide apheresis treatment, at the apheresis facility, to patients identified and managed by the local medical practice.

### CROSS-REFERENCE TO RELATED APPLICATIONS

This application claims priority to Applicant's copending U.S. Provisional Application Ser. No. 60/736,292 entitled “MEDICAL SERVICES BUSINESS ORGANIZATION” filed Nov. 15, 2005, the entirety of which is incorporated by reference herein.

### BACKGROUND OF THE INVENTION

1. Field of the Invention

The present invention relates to a method and system for creating an organization and structure for providing specialized medical services to one or more patients followed primarily by one or more different disease managing medical practices.

2. Background of the Technology

Therapeutic Apheresis (“TA”) is generically defined as an extracorporeal medical procedure used for filtering a patient's blood to remove disease-causing agents. TA includes procedures, such as methods involving Plasmapheresis, Cytapheresis and other advanced cellular therapies, including, for example, stem cell therapies and dendritic cell therapies. Over the past three decades, TA in the United States has been relegated almost exclusively to the in-hospital management of relatively rare diseases. Only a relatively low number of U.S. physicians have thus had any direct clinical training in, or even indirect experience with, performing apheresis-related procedures.

However, two recent watershed events have coalesced to position the TA industry to undergo the most dramatic and fundamental transformation in its history.

First, the development pipeline of new TA technologies for the treatment of common medical conditions is nearing the end of its regulatory pathway of clinical trials and U.S. Food and Drug Administration (“FDA”) approvals. New treatments, including plasma therapies, such as hemofiltration, double filtration, plasma exchange, cell exchanges, Photopheresis, and immunoadsorption, as well as advanced cellular therapies, such as selective leukocyte depletion, dendritic cell harvesting therapies, and peripheral blood stem cell therapies, are emerging that promise to revolutionize the practice of medicine as it is performed today.

Second, reimbursement guidelines promulgated on Jan. 1, 2005, by the Centers for Medicare and Medicaid Services (“CMS”) provide the means for physicians to be primarily reimbursed for apheresis-related services when performed in a non-facility (e.g., physician's office or private clinical) settings. An important point of distinction for this reimbursement policy change is the requirement that the physician shall be “on premises” in order to provide “direct supervision” of the apheresis-related procedure in order to qualify for such outpatient reimbursement. The term “direct supervision” is a term of art and stands in contradistinction to the term “general or indirect supervision,” which does not require a physician to be on site when services are performed.

Unfortunately, this requirement for on premises “direct supervision” by a physician, for the physician to qualify for non-facility TA procedure reimbursement, has stymied the introduction of these potentially revolutionary state-of-the-art procedures into established community-based medical practices. Such medical practices typically have little, if any, experience with apheresis-related procedures and services, and therefore have an understandable bias towards continuing to provide traditional therapeutic delivery methods and services. Even though physicians may want to provide patients with access to these new therapies, it is virtually impossible for the physicians to interrupt their busy schedules to undertake the training required, typically a one-year residency or fellowship, so as to become certified to provide TA procedures, while at the same time to be coverable under promulgated guidelines of typical medical malpractice carriers. Even if a physician were to obtain the requisite training and certifications, additional impediments arise, since incorporating TA technologies (or any similar disruptive, expensive, time-consuming, space-requiring, low-margin procedure) into their practice settings would most likely require, among other factors, diverting practice revenues, interrupting established patient flows, managing new technology expectations, cannibalizing office space, and training additional office staff.

One possible alternative that would satisfy the “direct supervision” requirement would be for the practice to hire physicians and/or skilled nursing personnel to perform the apheresis-related procedures in the office. However, the dearth of both available office space and contract apheresis-trained medical personnel makes the implementation of this alternative difficult. Another alternative would be to establish a satellite facility as a direct extension of the practice, where the apheresis-related procedures could be performed. However, the financial risks associated with such a venture would make it problematic for all but the very largest and most entrepreneurial medical practices to consider.

Additional factors that warrant consideration in devising a solution to the problems discussed above include the need to provide adequate financial compensation to physicians, in order for them to accept the risks associated with the performance, management, and/or supervision of any novel medical procedure provided to their patients. In addition, to be willing to adopt new procedures and related technologies as part of their practices, physicians would likely insist on retaining both diagnostic and therapeutic control over their patients. A further factor to consider is that repetitive medical procedures are best performed in settings where efficiencies can be maximized, especially in the face of declining reimbursement trends. Yet another factor is that, for patient care to be maximized and malpractice risks to be minimized, highly trained specialists must directly oversee the provision of medical procedures, especially extracorporeal methods.

An additional consideration involves the acute scarcity that exists in the United States for apheresis-trained medical personnel, especially once apheresis-related procedures become “FDA-approved” and commonly reimbursed for large population disease indications, such as Congestive Heart Failure, Hypercholesterolemia and Inflammatory Bowel Disease, among others.

Furthermore, physicians of similar specialties in private practice historically have had difficulty in working together, given the highly competitive nature of the medical industry and would, therefore, find it inconvenient to share services together to combine their practice populations to support the operations of a facility like a specialty apheresis facility.

In addition, there has been limited professional interaction among apheresis-trained physicians and community-based private practice physicians in many subspecialties, including cardiology, ophthalmology, gastroenterology, gerontology, and others serving large disease segments of the population.

Moreover, malpractice insurance coverage for apheresis-related procedures in non-facility venues necessitates that the provider: a) maintain applicable medical certifications; b) have the requisite experience to perform such apheresis-related procedures; and c) be available on the venue premises to directly supervise such procedures, as required by third-party payors.

Additionally, modern medical practices typically are contained in very complex, busy, high-stress environments. The majority of established practices are managed by highly proficient, competent teams of skilled medical professionals, who work diligently to maximize practice revenues in the face of declining reimbursement policies. Although medical practitioners frequently seek to expand their practice offerings, such as by adding new services and hiring new staff, there is a practical limit to the investment capacity, office space availability, management expertise, and time limitations associated with each such pursuit. Thus, physicians are finding it increasingly challenging to maintain practice incomes in an environment of declining reimbursements and increasing costs, while at the same time attempting to keep pace with the newest technological developments in a highly competitive industry.

The financial, personnel, and time investments associated with integrating new state-of-the-art medical therapeutic procedures into an ongoing medical practice setting can be daunting to the point of being prohibitive, especially if these new procedures are not specifically associated with the medical practice's historic core competency. Most practices are currently strained to their operating limits simply to provide their existing service offerings and have maximized their capacity for procedural through-put. As a result, they typically cannot add new services without substantial reorganization efforts and/or significant capital investment. Providing new services to expand a physician's practice is therefore difficult, if the practice is established and operating at or near capacity, notwithstanding a physician's desire to offer a new therapy to his or her patients.

Moreover, the increasing shortage of available skilled specialty nursing personnel and other procedural specialists is particularly severe, especially in apheresis, which exacerbates the difficulty of adding such non-core services. Providing new services is made even more difficult due to malpractice risks associated with incorporating new technologies, wherein any inadvertent misstep by inexperienced personnel could expose the physician's practice to unintended consequences, potential liability, and subsequent litigation.

Despite these issues, physicians as a group have consistently sought avenues to expand their practice. However, they must proceed with caution with respect to the means and methods under which such expansion may occur, since a number of legal and regulatory restrictions have been placed upon physician ownership arrangements in allied or affiliated medical services enterprises. Unlike many other professions, where the principals may have ownership interests in ancillary companies that augment or support the primary business, physicians operate under a unique set of restrictions with respect to ownership in laboratories, clinics, facilities, surgery centers, hospitals, and other similar practice-related enterprises. If a medical practice were to establish an ownership interest in such ancillary service improperly, the practice as a whole, as well as the individual physicians or providers, could face penalties under federal and state laws prohibiting self-referral, kickback, and fee-splitting arrangements, which requirements often confound even the best experts and invoke fears of incurring substantial financial fines, professional censure, and other penalties. Under such laws, a violating physician could face fraud and/or other severe felony charges for missteps occurring while navigating the complex maze of third-party (e.g., Medicare) guidelines. These, and other factors, have served to dampen enthusiasm with respect to medical practice expansion into non-core practice-related procedures and/or related business ventures.

Thus, if new apheresis-related procedures and services applicable to common medical conditions are to be introduced with any commercially reasonable adoption rate, a new method and system must be devised for their implementation into existing medical practices. Such a new method and system must complement the physician's existing practice and must allow patients to benefit from the availability of the new apheresis-related procedures and services without disrupting, cannibalizing, or encumbering these practices, ongoing practice environment and revenue streams.

Historically, specialty clinics (also known as “alternate site facilities”) have provided the most efficient means of delivering new medical procedures and have surmounted much of the adoption resistance encountered during the early commercialization period of many medical technologies and associated procedures newly-approved by the FDA. In the past, some medical service providers have followed an alternate site model of establishing specialty clinics to introduce leading edge technologies. However, the majority of these operations have historically induced physician participation through the establishment of joint ventures, partnerships or other forms of co-ownership, or other advantageous relationships with the providing facilities. Nevertheless, such arrangements have become increasingly problematic with recent restrictions on physicians' ownership of such facilities, which have forced physicians, in some cases, to divest their ownership in these facilities altogether.

There is a general need in the art, therefore, for methods and systems that provide attractive solutions for incorporating apheresis-related procedures and services into existing medical practices, thus providing much-needed new state-of-the-art medical therapy and patient services. There is a further need for methods and systems that efficiently incorporate apheresis-related procedures and services into existing medical practices, while avoiding any and all violations of federal and state statutes regarding physician ownership arrangements and other specified relationships in such practices.

There is yet a further need in the art for methods and systems for incorporation of apheresis-related procedures and services into existing medical practices that will allow these practices to benefit from the availability of new breakthrough technologies, procedures and services that can complement the practices, without disrupting or encumbering the ongoing medical practice environment and the associated revenue streams derived therefrom.

There is yet a further need in the art for methods and systems that provide attractive solutions for incorporating apheresis-related procedures and services into existing medical practices, without requiring substantial financial investment, addition of large numbers of new staff, and new clinical training or equipment.

### SUMMARY OF THE INVENTION

The present invention meets the above-identified needs, as well as others, by providing, in various embodiments, methods and systems incorporating apheresis-related therapies and patient services into existing medical practices, thereby avoiding restrictions on physicians' ownership of ancillary service suppliers and permitting physicians to take advantage of the ability to provide these new TA technologies within their practices. In one embodiment, the present invention provides for the formation of a parent company, which in turn creates one or more management companies, each of which manages at least one facility specializing in providing apheresis-related services and treatments. Each management company contracts with local physicians and/or medical practices that are interested in providing such services to their patients. Further, the management company provides the office space and equipment at the apheresis facility, and employs clinical staff to assist the physicians and/or medical practices in the provision of these services to patients, as well as specialists to serve as Medical Directors to oversee the clinical operation of the apheresis facility. In addition, the management company provides the local physicians/medical practices with marketing, billing and collections services, and medical practice management services. The local physicians and/or medical practices, in turn, employ a specialist physician trained in providing TA-related therapies, procedures and services, to provide these services to their patients at the apheresis facility. In one embodiment, the medical director may be a part-time employee of the management company to oversee the clinical operation of the apheresis facility and a part-time employee of the local physician and/or medical practice to provide TA procedures to patients at the apheresis facility.

Details of these and other advantages and novel features of the invention will be set forth in part in the description that follows, and in part will become more apparent to those skilled in the art upon examination of the following or upon learning by practice of the invention.

This disclosure is not intended to limit the invention to the application of apheresis-related procedures and services only, as is more fully described herein. As will be recognized by those skilled in the art, other new, non-traditional or breakthrough medical service procedures could be incorporated into physicians' medical practices using similar methods, and are intended to be included under the scope of this disclosure.

### BRIEF DESCRIPTION OF THE FIGURES

The features of the invention will be more readily understood with reference to the following description and the attached drawings, wherein:

FIGS. 1A and B present an example flow diagram of functions performed in accordance with an embodiment of the present invention;

FIG. 2 presents an example flow diagram of functions performed in connection with billing and payment collection services performed in accordance with an embodiment of the present invention;

FIG. 3 presents an exemplary system diagram of various hardware components and other features, for use in accordance with an embodiment of the present invention;

FIG. 4 is a block diagram of various exemplary system components, in accordance with an embodiment of the present invention; and

FIG. 5 illustrates the interrelationships among a Specialty Management Services Organization, a Medical Director, a Disease-managing Medical Practice and a Specialist Apheresis Physician, in accordance with an embodiment of the present invention.

### DETAILED DESCRIPTION

The present invention provides a system and method for organizing and structuring community-based medical practices to expand their range of medical services offered to patients without requiring substantial financial investment, disrupting practice patterns, adding large numbers of new staff personnel, providing new clinical training, purchasing new equipment, cannibalizing office space, or disrupting patient through-put. The system and method of the present invention may substantially reduce or eliminate exposure of community based physicians to penalties under federal or state laws.

Prior to describing embodiments of the system and method of the present invention, applicable terms associated with an exemplary embodiment of the system and method of the present invention are explained below.

For the purposes of this exemplary embodiment, a Parent Company (interchangeably referred to herein as “the Company”) is the parent company of one or more local Specialty Management Services Organizations (“SMSOs”) that provide apheresis-related management services at Specialty Apheresis Facilities (“SAFs”).

The SMSO is typically a wholly owned or majority controlled subsidiary (or in an alternative embodiment—a franchisee) of the Company and defines a local scalable operating unit for the Company. Each SMSO enters into a relationship, such as a contractual relationship, with one or more Disease-managing Medical Practices (“DMPs”), to provide a variety of Practice Management Services to patients of the DMPs. For example, the SMSO facilitates the medical practices of the DMPs, particularly and more specifically as disclosed herein with respect to providing apheresis-related services to the patients of the DMPs. In one embodiment, the Practice Management Services are provided to the DMPs at the SAF. Accordingly, each SMSO operates as a Management Services Organization for the DMPs.

In one embodiment, the SMSO does not perform any services that qualify as the practice of medicine, even when permitted by state law. Further, the SMSO is appropriately licensed where required by any and all applicable federal and or state laws.

A DMP is a medical practice that includes one or more physicians licensed to practice medicine in the state in which the SMSO is licensed by the Company to provide services. The DMP contracts with an SMSO and receives therefrom Practice Management Services associated with the apheresis-related procedures and services provided to qualified patients of the DMP. In one embodiment, the DMP has a contractual relationship (e.g., employment relationship) with a Specialist Apheresis Physician (“SAP”), whose functions are described below in more detail.

A SAF is a facility that is specifically designed and outfitted to provide apheresis-related procedures and services. For example, a SAF may serve as the satellite office for each DMP with which the SMSO contracts. The SAF may also include offices of one or more Medical Directors, who have a contractual relationship (e.g., employment relationship) with the SMSO, and one or more business offices of the local SMSO. In one embodiment, the SAF is located at the SMSO offices.

In one embodiment, the SAF is located within medical suites or campuses of a medical community, typically in or near a large medical/hospital center. Such a location helps integrate the SAF and the services offered by the SMSO with established medical services providers within the local medical community and remove potential uncertainty and confusion associated with Apheresis Medicine. The SAF is staffed by business and TA professionals, such as Medical Directors, Physician's assistants, nurse managers, experienced Apheresis Nurses, lab technicians, patient educators, marketing specialists, office managers, reception personnel, medical records personnel, and billing specialists although this list is not intended to be all-inclusive. The business and TA personnel represent the Company and perform the Company's brand of apheresis-related programs in the local area where the SAF is located.

A SAP is a physician (e.g., M.D. or D.O.) with a Hemapheresis certification, specialty training, and/or commensurate experience in apheresis, who is currently licensed to practice medicine in the state in which the SAF is located and who is coverable under nominal malpractice underwriting guidelines to perform apheresis-related procedures and services in a SAF, or other non-hospital-outpatient environment. The SAP may be an employee, such as a part-time employee, of one or more local Disease-managing Medical Practices (“DMPs”) that contract with a SMSO and that provide apheresis-related services to their patients at a particular SAF. As an employee of a DMP, the SAP typically evaluates patients who are designated as being potential candidates for one or more apheresis-related procedures and services. Once the SAP determines that the candidate patient is medically qualified to undergo an apheresis-related procedure, the SAP prescribes an appropriate Apheresis Protocol and schedules the patient to receive the apheresis-related procedure. Thereafter, the SAP provides direct medical supervision of the administration of the apheresis-related procedure to the patient at the SAF.

In one embodiment, the SAP is employed by multiple DMPs. Each employment relationship between the SAP and a DMP is independent and, in one embodiment, includes a written contractual arrangement.

A “Medical Director” is a physician (e.g., M.D. or D.O.) who is an employee (e.g., part-time) of the SMSO and provides management and administrative services to the DMP, and serves as a Medical Director of the SMSO. In one embodiment, the Medical Director of the local SMSO is also the SAP employed by the local DMP. The Medical Director provides medical administrative services, such as overseeing the creation and documentation of the SMSO's Standard Operating Procedures, chairing various committees of the SMSO, such as the Quality Assurance/Quality Control committees, assisting with staff selection and hiring, and overseeing staff training. In a further embodiment, the Medical Director is also responsible for directing research activities of the SMSO for the Company.

In one embodiment, an employment relationship between the Medical Director and the SMSO includes a written contractual agreement. In a further embodiment, the contractual agreement includes such provisions as those establishing compensation based on a fixed monthly fee based on market rates, a Confidentiality and Non-Disclosure provision, a Non-Competition and Non-Circumvention provision, or operating license from the SMSO or directly from the company as the case may be and a Liquidated Damages provision.

In one embodiment, a portion of the compensation package for the Medical Director includes a form of stock options in the Company and an employment benefits package.

Practice Management Services are contracted services provided by the SMSO to the DMPs relating to the administration of apheresis-related procedures and services to the patients of the DMPs. The SMSO also provides the office space and equipment at the SAF. Practice Management Services include, for example, services related to the administration of office space and equipment, and management of licensed medical support staff (e.g., nurses, physicians' assistants, medical technologists, laboratory technicians, machine technicians), necessary to provide apheresis-related treatments to qualified patients. Practice Management Services include providing access to on-site laboratory services, such as a Clinical Laboratory Improvement Act (“CLIA”) certified laboratory to conduct routine lab testing necessary for providing apheresis treatments (e.g., basic blood tests and/or coagulation tests) or cell processing, storage and shipping and receiving activities as may be required for cell therapies conducted by the SMSO. Practice Management Services may be performed or provided by the Company and/or the SMSO, and may further include insurance prequalification services for DMP's candidate patients; billing and collection services for apheresis-related procedures; patient education, counseling, and scheduling and coordinating services; and Practice Marketing, which includes a broad range of services, such as direct patient marketing, and print and radio advertising.

Apheresis-related procedures and services are those procedures and services that involve the removal of disease-promoting agents from a patient's blood through apheresis-related procedures and/or equipment. Example of apheresis-related procedures and services include, but are not limited to Therapeutic Plasma Exchange, Double Filtration Apheresis, Hemoperfusion, Immunoadsorption, Photopheresis, Cell Exchange, Cell Depletion, Cell Harvesting and Peripheral Blood Stem Cell Collections, among others.

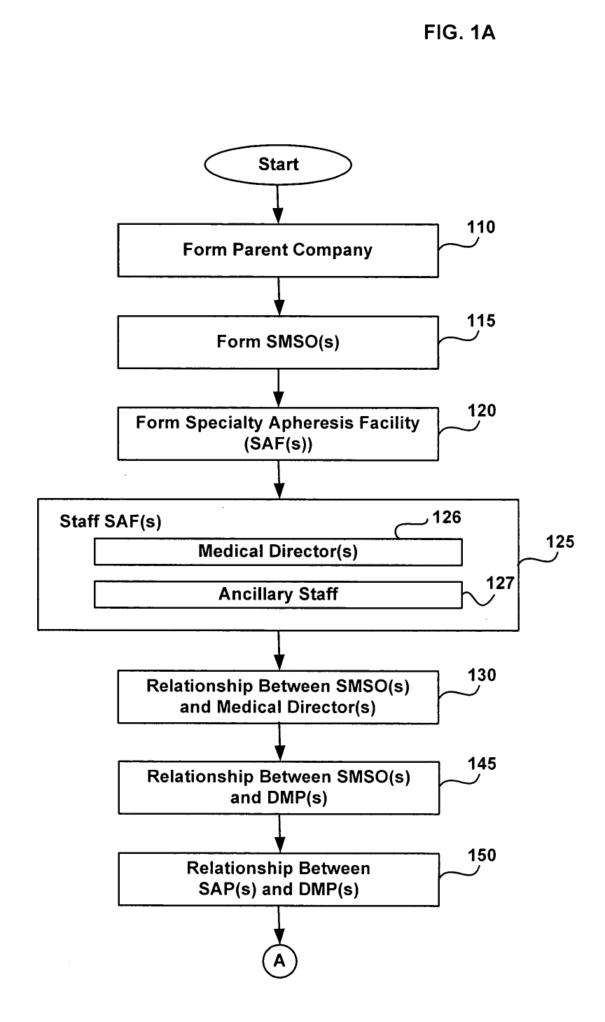

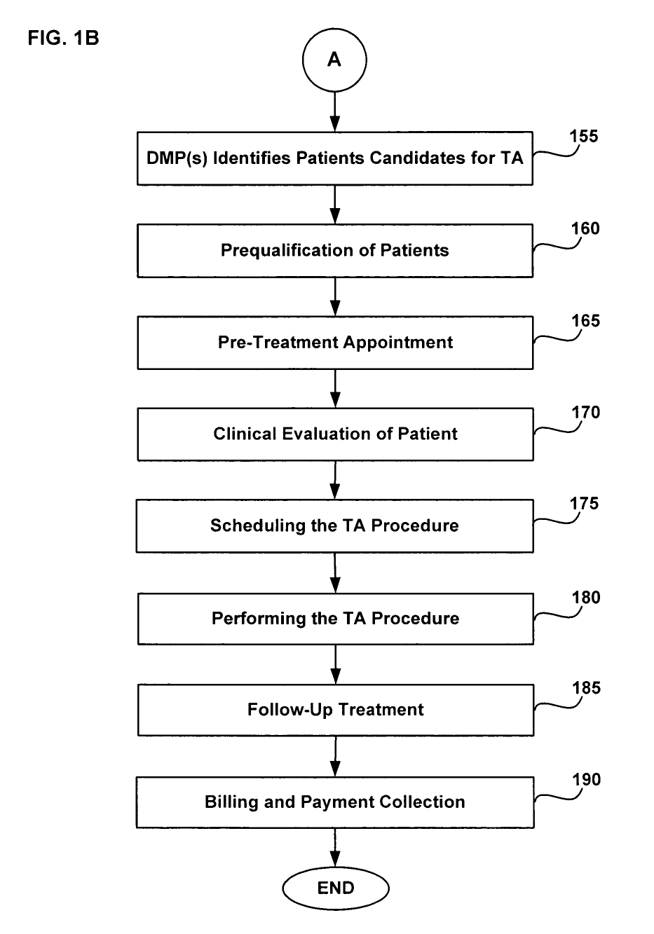

An example flow diagram of functions performed in accordance with an embodiment of the present invention will now be described in conjunction with FIGS. 1A and 1B. Referring now to FIG. 1A, a Parent Company is formed 110, which in turn forms one or more SMSOs 115, which are wholly-owned or majority controlled local companies, such as subsidiaries or franchisees, designed to oversee the provision of the Company's brand of apheresis-related procedures and services in a designated geographic area. Each SMSO may be staffed with employees who are experienced in sales, marketing and management of professional offices (e.g., medical offices and specialty clinics) and who establish one or more local SAFs 120 and hire the necessary core medical personnel 125 (e.g., one or more Medical Directors and/or other ancillary staff needed to perform the start-up functions at the SAF and the Practice Management Services for local physicians and/or medical practices and DMPs).

Each SMSO also enters into a relationship with the one or more Medical Directors 130, which may include, for example, a written contractual agreement outlining the respective roles and responsibilities of SMSO and the Medical Director(s).

Each SMSO may, via marketing or other means, contact local physicians and/or medical offices in the surrounding area (e.g., a large metropolitan area) that have patients who would benefit from the SMSO's apheresis-related procedures and services, provided at the SAF. Each SMSO informs the local physicians and/or medical offices of its Practice Management Services and SAF capabilities, and contracts with those local physicians and/or medical offices that are interested in offering TA-related services to their patients 145. Each SMSO enters into a relationship with the selected local physicians/medical practices which could include one or more office locations in or around the vicinity of the SMSO facility 145 (alternatively referred to herein as DMPs). The relationship between them may include, for example, a written contractual agreement regarding provision of apheresis-related procedures and services and Practice Management Services.

The SAP(s) enter into a relationship with a DMP to provide certain Apheresis-related services at the SAF as an employee of the DMP 150. In one embodiment, the relationship between the SAP and the DMP(s) is embodied in a written contractual agreement specifying the rights and obligations of the parties.

Referring now to FIG. 1B, each DMP identifies and/or diagnoses candidate patients who are potentially eligible for apheresis-related procedures and services 155. Each candidate patient is pre-qualified for the scheduled apheresis-related procedure 160, such as with the patient's insurance provider (if the candidate patient's medical insurance provider requires such pre-qualification) by, for example, the staff of the SMSO. Once pre-qualified, the candidate patient is scheduled for a pre-treatment appointment at SAF 165, where the patient may meet with, for example, a Patient Education Specialist and a SAP.

In one embodiment, upon arrival at SAF, the candidate patient may be seen in a pre-treatment consultation/appointment by a Patient Education Specialist and may be provided with all relevant information needed and/or requested to prepare for undergoing an apheresis-related procedure. The relevant information may include presentation and discussion of the patient's Informed Consent for Medical Treatment form, and a financial responsibility statement. During the pre-treatment consultation/appointment 165, the candidate patient may also meet with the SAP (or with the SAP's assistant, under the direct supervision of the SAP) who evaluates the candidate patient to determine the patient's clinical eligibility 170 to undergo an apheresis-related procedure based, for example, on a thorough past medical history and physical examination, including an evaluation of venous access, and any laboratory tests required for the specific apheresis-related procedure to be performed.

Once the clinical evaluation 170 is completed and the candidate patient is determined to be qualified by SAP to undergo the apheresis-related procedure, the SAP may review the patient's Informed Consent for Medical Treatment form with the patient and, subsequent to appropriate execution of the documents, the patient may be scheduled to return for an appointment to perform the apheresis-related procedure 175 at the SAF. In one embodiment, a prescription for the appropriate Apheresis protocol is written by the SAP and is subsequently filed in the patient's chart.

The patient then undergoes the scheduled apheresis-related procedure 180 under the direct supervision of the SAP. In one embodiment, the SAP maintains an office that is co-located at, near, adjacent to or within the SMSO and/or its SAF facility, or on the DMP premises if the SAF is located there, as defined by the term “on premises,” as such term is then defined under, and subject to, any and all relevant third-party payor guidelines.

Post-treatment, the progress of patient is followed 185 by, e.g., the SAP and/or other members of the DMP, in accordance with appropriate medical practice guidelines, standards of care and Standard Operating Procedures, to ensure the best possible clinical outcome and maximum patient safety.

The billing and collections group provided by the Company and or the personnel located at the SMSO prepares, processes and submits the procedure invoice to the payor or the patient, as the case may be, and collects payment 190.

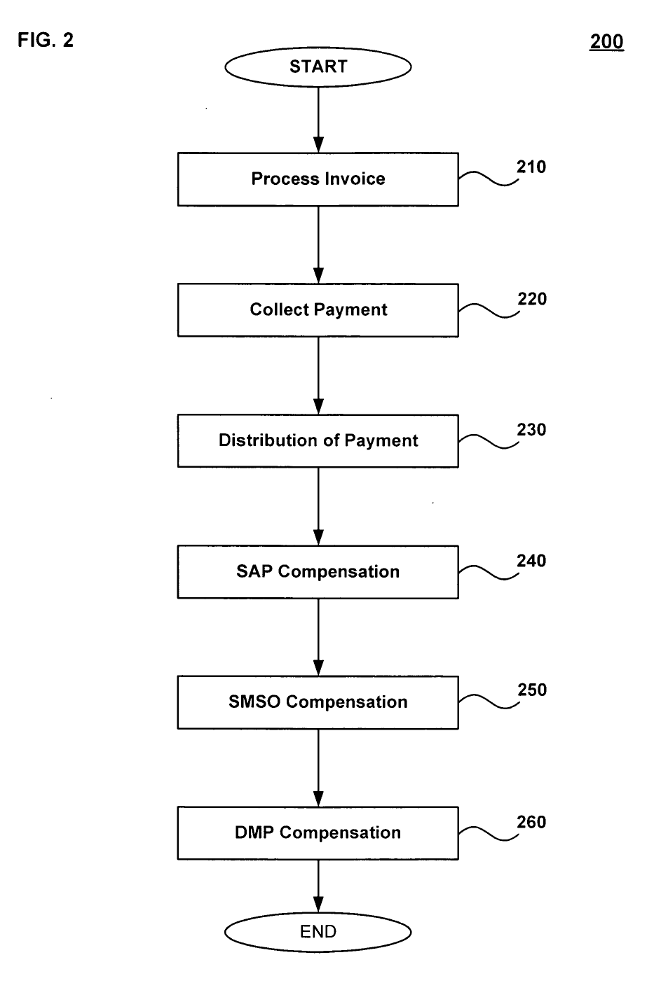

The billing and payment collection procedure 190 is presented in more detail in FIG. 2, in accordance with an embodiment of the present invention. Referring now to FIG. 2, after processing and presenting the procedure invoice to the patient and or the payor 210, as the case may be, and upon collection and receipt of payment 220, the payment may be deposited, for example, into an account or other repository, from which distribution is to be made to the relevant parties involved 230. In one embodiment, the distribution or so called “lockbox” account may be established by the DMP (alternatively referred to herein as a “sweep account”), with distribution instructions to sweep certain of the proceeds to at least two or more, preferably to three different accounts, including one to which the SAP has access and control, one to which the SMSO has access and control, and one to which the DMP has access and control, as provided in and under the terms of the agreements between the SMSO and the DMP, and in the separate agreement between the DMP and the SAP.

In another embodiment, upon collection 220, payment may be deposited into a “sweep account” established by the DMP, with distribution instructions to sweep the proceeds to another account to which the SMSO has access and control. The SMSO retains its fees under the terms of the agreement with the DMP, and distributes the remaining amount to another account to which the DMP has access, whereupon the DMP compensates the SAP according to the terms of the employment agreement between the DMP and the SAP.

It will be recognized by those skilled in the art, however, that alternative invoicing/payment arrangements are possible, and that those arrangements are typically repeated often and as frequently as a billable event occurs when the patient is treated, as some protocols require repetitive apheresis-related procedures to complete the therapeutic regimen, which would include any maintenance procedures as may be required over time.

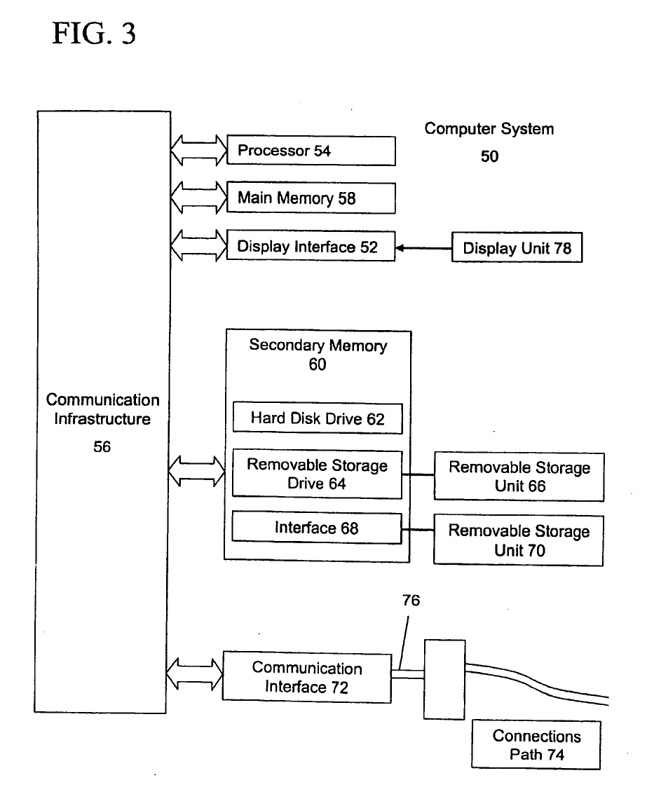

Regarding implementation, the present invention may be implemented using hardware, software or a combination thereof and may be implemented in one or more computer systems or other processing systems. In one embodiment, the invention is directed toward one or more computer systems capable of carrying out the functionality described herein. An example of such a computer system 50 is shown in FIG. 3.

Computer system 50 includes one or more processors, such as processor 54. The processor 54 is connected to a communication infrastructure 56 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 50 can include a display interface 52 that forwards graphics, text, and other data from the communication infrastructure 56 (or from a frame buffer not shown) for display on the display unit 78. Computer system 50 also includes a main memory 58, preferably random access memory (“RAM”), and may also include a secondary memory 60. The secondary memory 60 includes, for example, a hard disk drive 62 and/or a removable storage drive 64, representing a floppy disk drive, a magnetic tape drive, an optical disk drive, flash drive etc. The removable storage drive 64 reads from and/or writes to a removable storage unit 66 in a well-known manner. Removable storage unit 66, represents a floppy disk, magnetic tape, optical disk, etc., which is read by and written to removable storage drive 64. As will be appreciated, the removable storage unit 66 includes a computer usable storage medium having stored therein computer software and/or data.

In alternative embodiments, secondary memory 60 includes other similar devices for allowing computer programs or other instructions to be loaded into computer system 50. Such devices include, for example, a removable storage unit 70 and an interface 68. Examples of such may include a program cartridge and cartridge interface (such as that found in video game devices), a removable memory chip (such as an erasable programmable read only memory (“EPROM”), or programmable read only memory (“PROM”)) and associated socket, and other removable storage units 70 and interfaces 68, which allow software and data to be transferred from the removable storage unit 70 to computer system 50.

Computer system 50 also includes, for example, a communications interface 72. Communications interface 72 allows software and data to be transferred between computer system 50 and external devices. Examples of communications interface 72 may include a modem, a network interface (such as an Ethernet card), a communications port, a Personal Computer Memory Card International Association (“PCMCIA”) slot and card, etc. Software and data transferred via communications interface 72 are in the form of signals 76, which may be electronic, electromagnetic, optical or other signals capable of being received by communications interface 72. These signals 76 are provided to communications interface 72 via a communications path (e.g., channel) 74. This path 74 carries signals 76 and may be implemented using wire or cable, fiber optics, a telephone line, a cellular link, a radio frequency (“RF”) link and/or other communications channels. In this document, the terms “computer program medium” and “computer usable medium” are used to refer generally to media such as a removable storage drive 64, a hard disk installed in hard disk drive 62, and signals 76. These computer program products provide software to the computer system 50. The invention is directed to such computer program products.

Computer programs (also referred to as computer control logic) are stored in main memory 58 and/or secondary memory 60. Computer programs may also be received via communications interface 72. Such computer programs, when executed, enable the computer system 50 to perform the features of the present invention, as discussed herein. In particular, the computer programs, when executed, enable the processor 54 to perform the features of the present invention. Accordingly, such computer programs represent controllers of the computer system 50.

In an embodiment where the invention is implemented using software, the software may be stored in a computer program product and loaded into computer system 50 using removable storage drive 64, hard drive 62, or communications interface 72. The control logic (software), when executed by the processor 54, causes the processor 54 to perform the functions of the invention as described herein. In another embodiment, the invention is implemented primarily in hardware using, for example, hardware components, such as application specific integrated circuits (“ASICs”). Implementation of the hardware state machine so as to perform the functions described herein will be apparent to persons skilled in the relevant art(s).

In yet another embodiment, the invention is implemented using a combination of both hardware and software.

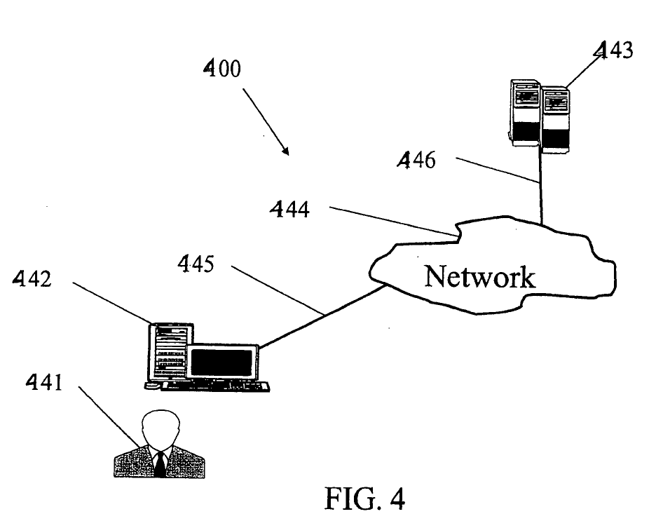

FIG. 4 shows a system 400 usable in accordance with an embodiment of the present invention. The communication system 400 includes an accessor 441 (also referred to interchangeably herein as a “user”) and a terminal 442. In one embodiment, data for use in accordance with the present invention is, for example, input and/or accessed by the accessor 441 via the terminal 442, such as a personal computer (PC), minicomputer, mainframe computer, microcomputer, telephonic device, or wireless device, such as a personal digital assistant (“PDA”) or a hand-held wireless device coupled to a server 443, such as a PC, minicomputer, mainframe computer, microcomputer, or other device having a processor and a repository for data and/or connection to a processor and/or repository for data, via, for example, a network 444, such as the Internet or an intranet, and couplings 445, 446. The couplings 445, 446 include, for example, wired, wireless, or fiberoptic links. In another embodiment, the method and system of the present invention operate in a stand-alone environment, such as on a single terminal.

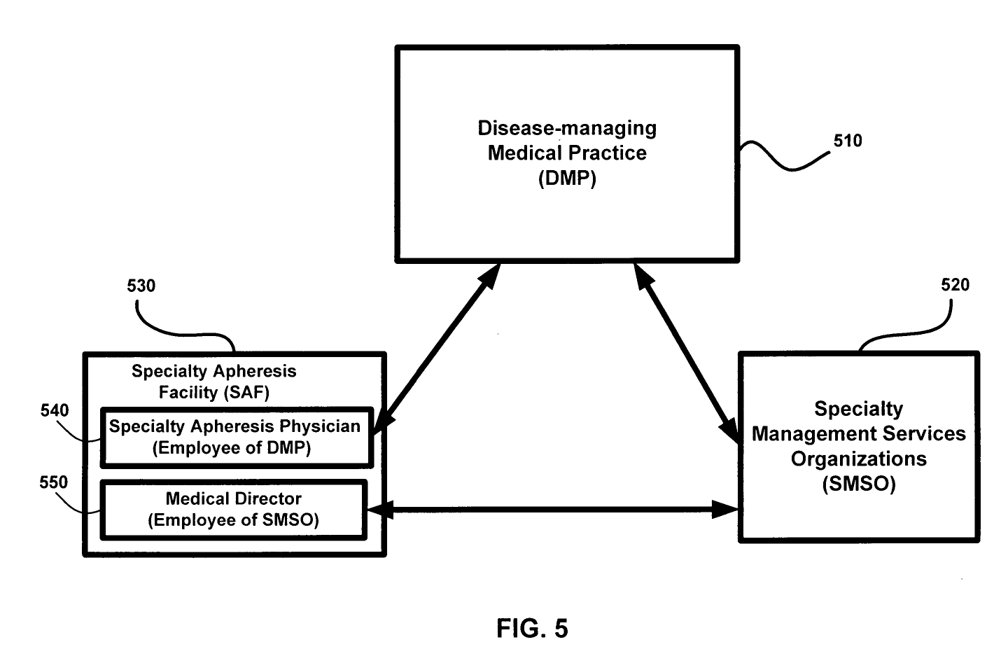

Referring now to FIG. 5, an example description of the interrelationships and the respective roles performed among an exemplary DMP 510, and exemplary SAP 540, an exemplary SMSO 520, and an exemplary Medical Director 550, for the provision of TA-related procedures and services at an exemplary SAF 530, will provided in conjunction with an embodiment of the present invention.

SMSO 520 establishes the SAF 530, which comprises the venue for performing apheresis-related procedures and services, and provides, for example, office space, staff, machines, inventory, and disposables, among other items. The SMSO 520 further forms a contractual relationship with DMP 510 for the provision of services, such as practice marketing, billing and collection services related to the apheresis procedures, and medical practice management services. The SMSO 520 employs at least one Medical Director 550 to oversee the provision of these services to the DMP, in addition to overseeing all apheresis-related procedures, performance of research and development duties, and related administrative functions.

DMP 510 identifies patients as potential candidates for apheresis-related treatment, forms a contractual employment relationship (e.g., for part-time employment) with SAP 530, and forms another contractual relationship with SMSO 520 for the provision of services, such as practice marketing, billing and collection services related to the apheresis procedures, and medical practice management services. The SMSO also provides the office space and equipment at the SAF.

SAP 540 forms an employment relationship (e.g., for part-time employment) with DMP 510 for medical pre-qualification of patients for apheresis-related procedures and services, and for performance and/or direct supervision of all apheresis procedures at SAF 530. In one embodiment, the functions of the Medical Director 550 and SAP 540 at the SAF 530 may be performed by the same individual.

With respect to the parent company and the SMSO(s), embodiments of the present invention provide the following advantages and benefits, among others. The present invention helps maximize the operating efficiencies for apheresis-related procedures and the safety of each patient undergoing evaluation and treatment. In addition, the Parent Company's business is consolidated and centralized into discrete, scalable business units that operate in a highly autonomous manner at the local level, thereby reducing the need for excessive layers of management and providing an expense savings vehicle, with enhanced decision-making capabilities. Furthermore, the present invention helps to provide a unique operations platform upon which to market the parent company's brand name(s), in addition to a nationwide infrastructure for conducting and facilitating research contracts with partners requiring apheresis expertise. The present invention also helps maximize the quality of the apheresis therapies delivered on a nationwide basis, and to expand the potential scope of approved indications for apheresis procedures, based on documented scientific support gained through standardized rigorous clinical observations. Finally, the present invention provides a parent company with an opportunity to develop extensive relationships with third-party payors, in order to assure coverage and develop appropriate reimbursement strategies for funding apheresis procedures, as well as to provide a mechanism to bestow rational incentives based on tangible results observable at a local level to clinic employees, where progress (e.g., profits) is made in response to local decisions and actions predominantly within the control of the local team.

With respect to the SAP(s), embodiments of the present invention provide benefits and advantages that include the following. The present invention provides a venue for SAPs to provide state-of-the-art apheresis-related procedures and services to patients, and a lucrative private practice model designed to attract the best apheresis practitioners in the country. Further, the present invention helps maximize the operating efficiencies for apheresis-related procedures and ensure the safety of each patient undergoing evaluation and treatment.

With respect to the local physicians and/or medical practices, among other things, embodiments of the present invention provide a simple, straightforward and direct way to introduce new therapies without requiring significant financial investment, disrupting practice patterns, adding large numbers of new staff members to the physicians' medical practices, requiring new clinical training, installing new equipment, requiring extra office space, or disrupting patient through-put. In addition, the present invention allows physicians to expand therapeutic treatments offered by their practices, thus potentially growing the practice with new patients. Moreover, the present invention helps to enhance the professional standing of the physicians' practice, which will be seen as providing leadership within the medical community, and to incur the respect and loyalty of patients within the practice who see their doctor as innovative and committed to their welfare.

With respect to insurance companies and/or other payors, among other things, embodiments of the present invention provide a cost-effective therapeutic alternative to existing therapies, as well as access to real-time clinical outcome data, which will assist the decision-making process regarding funding choices for specific targeted patient populations.

Finally, with respect to patients, among other things, embodiments of the present invention provide increased and convenient access to leading-edge medical procedures and cost-effective therapeutic alternatives to existing therapies provided by a highly trained medical staff.

Example embodiments of the present invention have now been described in accordance with the above advantages. It will be appreciated that these examples are merely illustrative of the invention. Many variations and modifications will be apparent to those skilled in the art.

Moreover, while numerous embodiments of the system and method of the present invention have been described in relation to apheresis-related procedures, it is within the scope of the present invention to apply the system and method of the present invention with any medical procedure, particularly new medical treatments that are not widely practiced for the reasons explained above. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for providing specialty medical services, the method comprising:
forming a specialty management services organization;
forming at least one specialty medical facility, under the specialty management services organization, for provision of the specialty medical services in a geographical area;
staffing the specialty facility with at least one specialty medical services provider;
creating contractual relationships among the at least one specialty management services organization, the at least one specialty medical services provider; and the at least one local medical practice having patients eligible for specialty medical services; and
obtaining performance of the specialty medical services for the eligible patients at the specialty medical facility.

2. The method of claim 1, wherein creating contractual relationships further comprises:
creating a first relationship between the at least one specialty management services organization and the at least one specialty medical services provider;
creating a second relationship between the at least one specialty management services organization and the at least one selected local medical practice; and
creating a third relationship between the at least one selected local medical practice and the at least one specialty medical services provider.

3. The method of claim 2, wherein the first relationship is an employment agreement.

4. The method of claim 2, wherein the second relationship is a contract for the performance of management and administrative functions by the at least one specialty management services organization.

5. The method of claim 2, wherein the third relationship is an employment relationship.

6. The method of claim 1, wherein the specialty medical services are apheresis-related services.

7. The method of claim 1, wherein a parent company is established for the at least one specialty management services organization.

8. The method of claim 1, wherein the performing of specialty medical services to the eligible patients at the specialty medical facility is under the direct supervision of the at least one specialty medical services provider.

9. The method of claim 1, further comprising:
prequalifying the eligible patients prior to obtaining performance of the specialty medical services;
conducting a clinical evaluation of the eligible patients prior to obtaining performance of the specialty medical services; and
conducting follow-up treatment after obtaining performance of the specialty medical services.

10. The method of claim 1, further comprising:
providing billing and payment collection services related to the performing of the specialty medical services.

11. The method of claim 10, wherein providing billing and collection services further includes:
processing an invoice for the specialty medical services;
collecting payment for the specialty medical services; and
distributing the payment for the specialty medical services.

12. The method of claim 10, further comprising:
compensating the at least one selected local medical practice;
compensating the at least one specialty management services organization; and
compensating the at least one specialty medical services provider.

13. A system for providing specialty medical services, the system comprising:
means for forming a specialty management services organization;
means for forming at least one specialty medical facility, under the specialty management services organization, for provision of the specialty medical services in a geographical area;
means for staffing the specialty facility with at least one specialty medical services provider;
means for creating contractual relationships among the at least one specialty management services organization, the at least one specialty medical services provider; and the at least one local medical practice having patients eligible for specialty medical services; and
means for obtaining performance of the specialty medical services for the eligible patients at the specialty medical facility.

14. A system for providing specialty medical services, the system comprising:
a processor;
a user interface functioning via the processor; and
a repository accessible by the processor;
wherein a specialty management services organization is formed;
wherein at least one specialty medical facility is formed, under the specialty management services organization, for provision of the specialty medical services in a geographical area;
wherein the specialty facility is staffed with at least one specialty medical services provider;
wherein contractual relationships are created among the at least one specialty management services organization, the at least one specialty medical services provider; and the at least one local medical practice having patients eligible for specialty medical services; and
wherein performance of the specialty medical services are obtained for the eligible patients at the specialty medical facility.

15. The system of claim 14, wherein the processor is housed on a terminal.

16. The system of claim 15, wherein the terminal is selected from a group consisting of a personal computer, a minicomputer, a main frame computer, a microcomputer, a hand held device, and a telephonic device.

17. The system of claim 14, wherein the processor is housed on a server.

18. The system of claim 17, wherein the server is selected from a group consisting of a personal computer, a minicomputer, a microcomputer, and a main frame computer.

19. The system of claim 17, wherein the server is coupled to a network.

20. The system of claim 19, wherein the network is the Internet.

21. The system of claim 19, wherein the server is coupled to the network via a coupling.

22. The system of claim 21, wherein the coupling is selected from a group consisting of a wired connection, a wireless connection, and a fiberoptic connection.

23. The system of claim 14, wherein the repository is housed on a server.

24. The system of claim 23, wherein the server is coupled to a network.

25. A computer program product comprising a computer usable medium having control logic stored therein for causing a computer to provide specialty medical services, the control logic comprising:
first computer readable program code means for forming a specialty management services organization;
second computer readable program code means for forming at least one specialty medical facility, under the specialty management services organization, for provision of the specialty medical services in a geographical area;
third computer readable program code means for staffing the specialty facility with at least one specialty medical services provider;
fourth computer readable program code means for creating contractual relationships among the at least one specialty management services organization, the at least one specialty medical services provider; and the at least one local medical practice having patients eligible for specialty medical services; and
fifth computer readable program code means for obtaining performance of the specialty medical services for the eligible patients at the specialty medical facility.
